(19) United States
(12) Patent Application Publication
(10) Pub. No.: US 2008/0284968 A1
(43) Pub. Date: Nov. 20, 2008

(54) Display Device

(76) Inventors: Hyun Ha Hwang, Seoul (KR); Jang Ho Kim, Seoul (KR); Seung Rok Shin, Gyeonggi-do (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 12/091,305

(22) PCT Filed: Oct. 23, 2006
(86) PCT No.: PCT/KR2006/004334

§ 371 Date: Apr. 24, 2008

(30) Foreign Application Priority Data
Oct. 24, 2005 (KR) 10-2005-0100250

(51) Int. Cl. G02F 1/1345

(52) U.S. Cl. 349/151

(57) ABSTRACT

An embodiment of the present invention provides a display device including: a driver IC chip; a substrate disposed under the driver IC chip; a plurality of bump pads interposed between the driver IC chip and the substrate to input and output input/output signals for the driver IC chip, and arranged in at least three rows; and a plurality of conductive lines disposed on the substrate to electrically connect to the plurality of bump pads, respectively.

### TECHNICAL FIELD

The present invention relates to a display device.

### BACKGROUND ART

Among image display devices that display image information, a thin film-type flat display device is light and also can be easily used in any place. Therefore, it has been intensively developed in recent years.

Especially, since a liquid crystal display device has a high-resolution and a fast response time capable of displaying moving pictures, it has been the most actively developed display device. A main principle of the liquid crystal display device takes advantages of optical anisotropy and polarization of liquid crystal. That is, when an alignment direction of a liquid crystal molecule with directionality is artificially adjusted according to polarizability, light can be transmitted or blocked by optical anisotropy according to an alignment direction of the liquid crystal. An image can be displayed by using this principle.

The liquid crystal display device includes a liquid crystal display panel having pixels in a matrix, and a gate driving unit and a data driving unit for driving the respective pixels.

The liquid crystal display panel includes a thin film transistor array substrate and a color filter substrate, which are attached to maintain a predetermined cell-gap, and a liquid crystal layer interposed between the thin film transistor array substrate and the color filter substrate.

In the color filter substrate, red, green and blue color filters are repeatedly disposed on positions of the pixels. A black matrix is formed between the color filters in a net form. A common electrode is formed on the color filter.

In the thin film transistor array substrate, pixel electrodes are arranged on positions of the pixels in a matrix. Gate lines are formed along a horizontal direction of the pixel electrode, and data lines are formed along a vertical direction. A thin film transistor is formed in a predetermined region of the pixel to drive the pixel electrode. The gate electrode of the thin film transistor is connected to the gate line. A source electrode of the thin film transistor is connected to the data line. A drain electrode of the thin film transistor is connected to the pixel electrode.

A gate pad part and a data pad part are formed on one ends of the gate lines and the data lines. The gate driving unit and the data driving unit are combined in various forms with the gate pad part and the data pad part in the liquid crystal display panel, thereby supplying scanning signals and image information into the gate lines and the data lines to drive the liquid crystal display panel.

A plurality of driver integrated circuit chips (hereinafter, referred to as a driver IC chips) are disposed on the gate driving unit and data driving unit. The driver IC chips are connected to the liquid crystal display panel by using various methods. In a tape automated bonding (TAB) method, the driver IC chips are mounted on a tape carrier package (TCP) to attach to the gate pad part and the data pad part of the thin film transistor array substrate. In a chip-on-glass (COG) method, the driver IC chips are directly mounted on the array substrate of the thin film transistor to attach to the gate pad part and the data pad part of the thin film transistor array substrate.

In methods of combining the driver IC chips with the liquid crystal display panel, the COG method has a simpler structure compared to the TAB method. Thus, processes of the COG method are simple, and manufacturing cost reduces. The liquid crystal display device using the COG method will be described in more detail with reference to drawings.

FIG. 1 is a plan view of an exemplary related art liquid crystal display device using a COG method.

Referring to FIG. 1, a liquid crystal display panel 110 is assembled by maintaining a predetermined cell-gap between an array substrate 111 and a color filter substrate 112 in the liquid crystal display panel 110. The liquid crystal layer is formed in the pre-determined cell-gap.

One short side and one long side of the thin film transistor array substrate 111 protrude more compared to the color filter substrate 112. The gate pad part and the data pad part are disposed on the protruding region of the thin film transistor array substrate 111. Additionally, an image display unit 113 is disposed in a combined region of the thin film transistor array substrate 111 and the color filter substrate 112.

In the thin film transistor array substrate 111, a plurality of gate lines 120 are disposed in a horizontal direction to connect to the gate pad part, and a plurality of data lines 130 are disposed in a vertical direction to connect to the data pad part. Accordingly, the gate lines 120 and the data lines 130 intersect each other to form pixels on intersection points of the gate lines 120 and the data lines 130. The pixels include the thin film transistors and the pixel electrodes.

In the color filter substrate 112, there are coated red, green and blue colors filters separated by a black matrix in each pixel, and common electrodes that form an electric field on a liquid crystal layer with pixel electrode disposed on the thin film transistor array substrate 111.

Gate driver IC chips 133 are mounted on one short side of the thin film transistor array substrate 111 that protrude more compared to the color filter substrate 112, and connected to the gate pad part. Data driver IC chips 133 are mounted on one long side of the thin film transistor array substrate 111 to connect to the data pad part.

FIG. 2 is an enlarged view of one long side in the liquid crystal display device of FIG. 1.

As illustrated in FIG. 2, a plurality of data pads 151 are formed on one long side of the thin film transistor array substrate 111 that protrude more compared to the color filter substrate 112. Additionally, one ends of the data pads 151 are connected to a plurality of data lines 130 that protrude from the image display unit 113. A plurality of output bumps 152 are formed on one ends of the data pads 151 and connection parts of the data lines 130. Additionally, a plurality of input bumps 155 are formed on edges of the thin film transistor array substrate 111, and spaced apart from a shorting bar 153.

The other ends of the data pads 151 are electrically short due to the shorting bar 153. Thus, the shorting bar 153 maintains the data lines 130 in electrical equipotential. Accordingly, static electricity can be prevented during a process of manufacturing the thin film transistor array substrate 111. Moreover, short defects can be easily tested in the data lines 130 of the completed thin film transistor array substrate 111.

As described above, since the actual liquid crystal display device can not be driven when the data lines 130 maintain an electrical equipotential by using the shorting bar 153, the shorting bar 153 needs to be removed. In a COG type liquid crystal display device, the data pads 151 and the shorting bar 153 are electrically opened through a laser trimming 154.

However, the latest small and medium liquid crystal display devices rapidly progress in an aspect of a high-resolution. Consequently, the number of the data lines and the gate lines in the small and medium liquid crystal display device increases.

On the other hand, a single chip has been embodied recently, in which the data driver and the gate driver in the liquid crystal display device are integrated in one chip. However, in the liquid crystal display device supporting a high-resolution, it is difficult to embody the single chip with a limited chip scale in a related art bump pad structure.

### DISCLOSURE OF INVENTION

### Technical Problem

An embodiment of the present invention provides a display device having a single chip in which a data driver and a gate driver of device drivers are efficiently integrated into one chip in a display device that supports a high-resolution.

### Technical Solution

An embodiment of the present invention provides a display device including: a driver IC chip; a substrate disposed under the driver IC chip; a plurality of bump pads interposed between the driver IC chip and the substrate to input and output input/output signals for the driver IC chip, and arranged in at least three rows; and a plurality of conductive lines disposed on the substrate to electrically connect to the plurality of bump pads, respectively.

An embodiment of the present invention provides a display device including: a driver IC chip; a substrate disposed under the driver IC chip; a plurality of bump pads interposed between the driver IC chip and the substrate to input and output input/output signals for the driver IC chip; and a plurality of conductive lines electrically connected to the plurality of bump pads, respectively, a portion of the conductive lines being formed on the top of the substrate, another portion of the conductive lines being formed on the bottom of the substrate.

### Advantageous Effects

An embodiment of the present invention provides a display device improving the degree of integration of bump pads in an identical chip size by increasing the number of output bump pads.

An embodiment of the present invention provides a display device improving resolution and reliability by embodying a plurality of bump pads.

### BRIEF DESCRIPTION OF THE DRAWINGS

FIG. 1 is a plan view of an exemplary related art liquid crystal display device using a COG method;

FIG. 2 is an enlarged view of one long side in the liquid crystal display device of FIG. 1;

FIG. 3 is an enlarged view of a bump pad part of a liquid crystal display device according to an embodiment of the present invention;

FIG. 4 is a perspective sectional view taken along a line A-A′ of FIG. 3;

FIG. 5 is an enlarged view of a bump pad part in a liquid crystal display device according to another embodiment of the present invention; and

FIG. 6 is a perspective sectional view taken along a line B-B′ of FIG. 5.

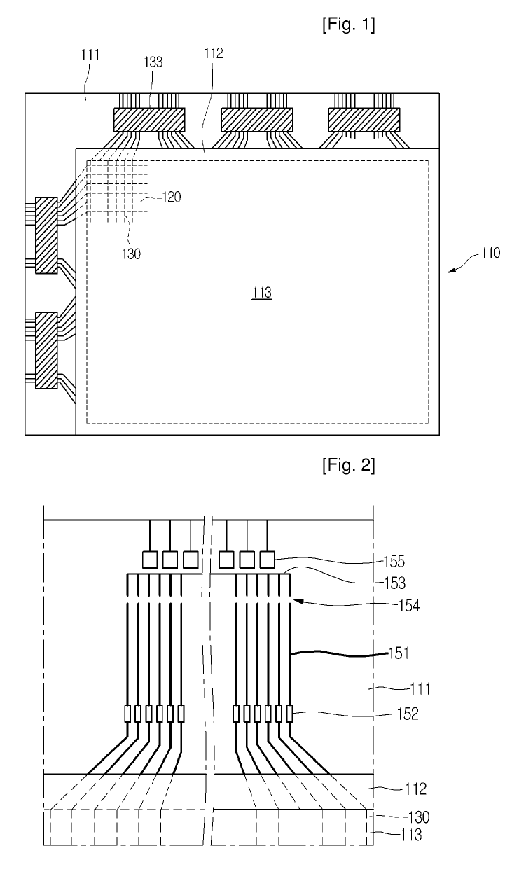

### MODE FOR THE INVENTION

Reference will now be made in detail to the embodiments of the present invention, examples of which are illustrated in the accompanying drawings.

A liquid display device according to an embodiment of the present invention is a chip-on-glass (COG) type in which a chip is mounted on a glass. However, an embodiment of the present invention is not limited to this, and can be applied to a chip-on-film type liquid crystal display device. Additionally, following description will be made in detail based on a liquid crystal display device, but the technical idea of an embodiment of the present invention can be applied to other display devices besides the liquid crystal display device.

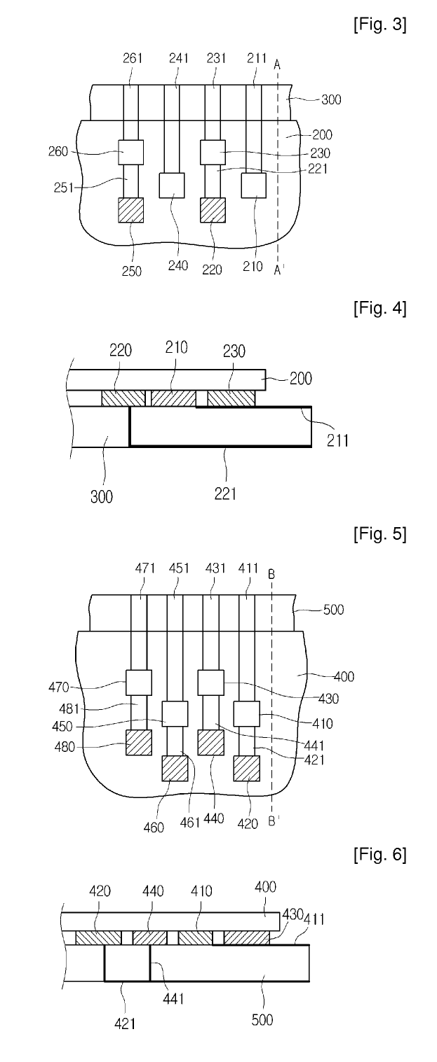

FIG. 3 is an enlarged view of a bump pad part of a liquid crystal display device according to an embodiment of the present invention. FIG. 4 is a perspective sectional view taken along a line A-A′ of FIG. 3.

Referring to FIG. 3, a bump pad part in a liquid crystal display device includes a glass substrate 300 formed on the bottom of a bump pad and a driver IC chip 200 formed on the top of the bump pad. A plurality of bump pads 210, 220, 230, 240, 250 and 260 are formed between the driver IC chip 200 and the glass substrate 300. A plurality of conductive lines 211, 221, 231, 241, 251 and 261 are connected to the plurality of bump pads 210, 220, 230, 240, 250 and 260, respectively.

The driver IC chip 200 is electrically connected to the plurality of bump pads 210, 220, 230, 240, 250 and 260 formed on the glass substrate 300. Predetermined drive signals are transmitted into a liquid crystal display unit (not shown) having a liquid crystal layer through the bump pads 210, 220, 230, 240, 250 and 260 and the conductive lines 211, 221, 231, 241, 251 and 261.

In the drive IC chip 200, a data driving driver and a gate driving driver can be integrated into a single chip.

Referring to FIG. 3, the bump pads 210, 220, 230, 240, 250 and 260 may be periodically formed by one bump pad or two bump pads along a conductive line.

The bump pads 210, 220, 230, 240, 250 and 260 may be formed in three rows along one side of the glass substrate 200. The bump pads 230 and 260 arranged in the first row and the bump pads 220 and 250 arranged in the third row are disposed parallel to each other with an identical interval. The bump pads 210 and 240 arranged in the second row are disposed diagonal to the bump pads 230 and 260 arranged on the first row.

As illustrated in FIG. 4, a conductive line 221, which is a conductive line having two bump pads along the conductive line, is formed on the bottom of the bump pad 220, penetrates the glass substrate 300, and passes through the bottom of the glass substrate 300 to connect to an external device such as a liquid crystal display part. Additionally, a conductive line 231 (which is omitted in FIG. 4 because it overlaps with the conductive line 211) is formed on the bottom one side of the bump pad 230 to connect to an external device such as a liquid crystal display part through the top surface of the glass substrate 300. The conductive lines 251 and 261 having two bump pads 250 and 260 are connected to an external device in a connection form and configuration which are identical to those of the two conductive lines 221 and 231 having the two bump pads 220 and 230.

Additionally, a conductive line having one bump pad, i.e., a conductive line 211 connected to the bump pad 210, is formed on the bottom one side of the bump pad 210, passes through the top surface of the glass substrate 300, and is connected to an external device such as a liquid crystal display unit. The bump pad 210 is arranged between the bump pad 220 and the bump pad 230 as illustrated in FIG. 4. Another conductive line 241 having one bump pad 240 and the bump pad 240 are connected to an external device in a connection form identical to that of the conductive lines 211 having the bump pad 210 and the bump pad 210.

The conductive lines 211, 221, 231, 241, 251 and 261 are in a line form through which electric signals are transmitted. The line form is one selected from the group including of wire, flexible printed circuits board (FPCB), and anisotropic conductive film (ACF). According to an embodiment of the present invention, the conductive lines 211, 221, 231, 241, 251 and 261 are in a FPCB form.

In the liquid crystal display device according to one embodiment of the present invention including the plurality of bump pads 210, 220, 230, 240, 250, and 260 and the conductive lines 211, 221, 231, 241, 251, and 261, intervals between the bump pads 210, 220, 230, 240, 250, and 260 formed on the glass substrate 300 are narrowly and diagonally spaced by considering the size of the driver IC chip 200 in advance as illustrated in FIG. 3. Accordingly, the number of bump pads increases and the degree of integration of the bump pads increases by 50% in an identical chip compared to the related art bump pads.

Hereinafter, a bump pad part in a liquid crystal display device according to another embodiment of the present invention will be described.

FIG. 5 is an enlarged view of a bump pad part in a liquid crystal display device according to another embodiment of the present invention. FIG. 6 is a perspective sectional view taken along a line B-B′ of FIG. 5.

Referring to FIG. 5, a bump pad part in a liquid crystal display device includes a glass substrate 500 formed on the bottom of a bump pad and a driver IC chip 400 formed on the top of the bump pad. A plurality of bump pads 410, 420, 430, 440, 450, 460, 470, and 480 are formed between the driver IC chip 400 and the glass substrate 500. A plurality of conductive lines 411, 421, 431, 441, 451, 461, 471, and 481 are connected to the plurality of bump pads 410, 420, 430, 440, 450, 460, 470, and 480, respectively.

The driver IC chip 400 is electrically connected to the plurality of bump pads 410, 420, 430, 440, 450, 460, 470, and 480 formed on the glass substrate 500. Pre-determined drive signals are transmitted into a liquid crystal display unit (not shown) having a liquid crystal layer through the bump pads 410, 420, 430, 440, 450, 460, 470, and 480 and the conductive lines 411, 421, 431, 441, 451, 461, 471, and 481.

In the drive IC chip 400, a data driving driver and a gate driving driver can be integrated into a single chip.

Each two bump pad in the bump pads 410, 420, 430, 440, 450, 460, 470, and 480 is diagonally disposed along the conductive line as illustrated in FIG. 5.

As illustrated in FIG. 5, in a case of the conductive lines 411 and 421 having the two bump pads 410 and 420, the conductive line 421 is connected to the bottom of the bump pad 420, penetrates the glass substrate 500, passes through the bottom of the glass substrate 500, and is connected to an external device such as a liquid crystal display unit. Additionally, the conductive line 411 is formed on the bottom of the bump pad 410, passes through the top surface of the glass substrate 500, and is connected to an external device such as a liquid crystal display unit.

Conductive lines 431 and 441 having the two bump pads 430 and 440, the conductive lines 451 and 461 having the two bump pads 450 and 460, the conductive lines 471 and 481 having the two bump pads 470 and 480 are connected to an external device in a connection form that is identical to that of the conductive lines 411 and 421 having the two bump pads 410 and 420.

The bump pads 410, 420, 430, 440, 450, 460, 470, and 480 are formed in four rows along one side of the glass substrate 400. The bump pads 430 and 470 arranged on the first row and the bump pads 440 and 480 arranged on the third row are disposed parallel to each other with an identical interval. The bump pads 410 and 450 arranged on the second row and the bump pads 420 and 460 arranged on the fourth row are disposed parallel to each other with an identical interval. The bump pads 430 and 470 arranged in the first row are disposed diagonal to the bump pads 410 and 450 arranged in the second row.

The conductive lines 411, 421, 431, 441, 451, 461, 471, and 481 are in a line form that is one selected from the group including of wire, FPCB, and ACF.

In the liquid crystal display device including the bump pads 410, 420, 430, 440, 450, 460, 470, and 480 and the conductive lines 411, 421, 431, 441, 451, 461, 471, and 481, intervals between the bump pads 410, 420, 430, 440, 450, 460, 470, and 480 formed on the glass substrate 500 are narrowly spaced by considering the size of the driver IC chip 400 in advance as illustrated in FIG. 5. Additionally, since the bump pads 410, 420, 430, 440, 450, 460, 470, and 480 are diagonally disposed to each other, the number of the output bump pads increases by double. Accordingly, the degree of integration of the bump pads increases by 100% in an identical chip compared to the related art bump pads. Here, since at least two bump pads are disposed along a conductive line direction, the degree of integration of the bump pads increases more.

As described above, there are two cases in which one case has the bump pads in three rows along one side of the glass substrate and another case has the bump pads in four rows. However, an embodiment of the present invention can be applied to all cases in which the bump pads are formed in at least three rows along one side of the glass substrate.

In the above description, an embodiment of the present invention is applied to the glass substrate as an example, but can be also applied to a flexible substrate such as a plastic substrate.

### INDUSTRIAL APPLICABILITY

An embodiment of the present invention provides a display device improving the degree of integration of bump pads in an identical chip size by increasing the number of output bump pads.

An embodiment of the present invention provides a display device improving resolution and reliability by embodying a plurality of bump pads.

1. A display device comprising:
a driver IC chip;
a substrate disposed under the driver IC chip;
a plurality of bump pads interposed between the driver IC chip and the substrate to input and output input/output signals for the driver IC chip, and arranged in at least three rows;
a plurality of conductive lines disposed on the substrate to electrically connect to the plurality of bump pads, respectively.

2. The display device according to claim 1, wherein the plurality of bump pads arranged in at least three rows are disposed along one side of the substrate.

3. The display device according to claim 1, wherein the plurality of bump pads arranged in at least three rows are formed diagonal to an adjacent bump pad row.

4. The display device according to claim 1, wherein at least one of the conductive lines penetrates the substrate and is formed on the bottom of the substrate.

5. The display device according to claim 1, wherein the plurality of conductive lines are formed in at least one line form selected from the group including wire, FPCB (flexible printed circuits board) and ACF (anisotropic conductive film).

6. The display device according to claim 1, wherein the display device is a liquid crystal display device.

7. The display device according to claim 6, wherein the driver IC chip comprises a gate driving driver and a data driving driver.

8. The display device according to claim 1, wherein the plurality of bump pads are formed in three rows along the one side of the substrate, the bump pads in first and third rows being disposed parallel to each other with an identical interval.

9. The display device according to claim 8, wherein the bump pads formed in the second row are disposed diagonal to the bump pads formed in the first row.

10. The display device according to claim 1, wherein the plurality of bump pads are formed in four rows along the one side of the substrate, the bump pads in first and third rows being disposed parallel to each other with an identical interval, the bump pads in second and fourth rows being disposed parallel to each other with an identical interval.

11. The display device according to claim 10, wherein the bump pads formed in the second row are disposed diagonal to the bump pads formed in the first row.

12. A display device comprising:
a driver IC chip;
a substrate disposed under the driver IC chip;
a plurality of bump pads interposed between the driver IC chip and the substrate to input and output input/output signals for the driver IC chip;
a plurality of conductive lines electrically connected to the plurality of bump pads, respectively, a portion of the conductive lines being formed on the top of the substrate, another portion of the conductive lines being formed on the bottom of the substrate.

13. The display device according to claim 12, wherein the plurality of conductive lines on the bottom of the substrate penetrate the substrate to electrically connect to the plurality of bump pads.

14. The display device according to claim 12, wherein the plurality of bump pads are arranged in at least three rows along one side of the substrate.

15. The display device according to claim 14, wherein the plurality of bump pads arranged in at least three rows are disposed diagonal to an adjacent bump pad row.

16. The display device according to claim 12, wherein the plurality of conductive lines are formed in at least one line form selected from the group including wire, FPCB, and ACF.

17. The display device according to claim 12, wherein the display device is a liquid display device.

18. The display device according to claim 17, wherein the driver IC chip comprises a gate driving driver and a data driving driver.

19. The display device according to claim 12, wherein the plurality of bump pads are formed in three rows along the one side of the substrate, the bump pads in first and third rows being disposed parallel to each other with an identical interval.

20. The display device according to claim 12, wherein the plurality of bump pads are formed in four rows along the one side of the substrate, the bump pads in first and third rows being disposed parallel to each other with an identical interval, the bump pads in second and fourth rows being disposed parallel to each other with an identical interval.
